(19) United States
(12) Patent Application Publication
(10) Pub. No.: US 2019/0359455 A1
(43) Pub. Date: Nov. 28, 2019

(54) TOWER CRANE

(71) Applicant: USUN (FOSHAN) TECHNOLOGY CO., LTD., Foshan (CN)

(72) Inventor: CHIU-FONG HUANG, New Taipei City (TW)

(21) Appl. No.: 16/229,271

(22) Filed: Dec. 21, 2018

(30) Foreign Application Priority Data
May 23, 2018 (CN) 201810503744.3

(51) Int. Cl. B66C 13/22; B66C 23/16; B66C 15/06; B66D 1/12; B66D 1/48; B66C 23/90

(52) U.S. Cl. CPC B66C 13/22; B66C 23/16; B66C 15/065; B66C 2700/0385; B66D 1/485; B66C 23/905; B66D 2700/025; B66D 1/12

(57) ABSTRACT

A tower crane under safety management and control includes a cargo boom, a spool and a pulley located on the cargo boom, a motor coupled to the spool, a hook, a 3D camera module, and a controller coupled to the 3D camera module and the motor. A tow rope of the spool rolls around the pulley and connects the hook. The 3D camera module includes a first camera facing the hook and a second camera back to the hook. The first and second cameras respectively take images, in real time. The controller obtains the images taken by the first camera when lifting a load downwards, obtains the images taken by the second camera when lifting the load upwards, detects whether there are obstacles within the images; and controls the motor reducing working speed or stopping working when there is an obstacle within the images.

### FIELD

The subject matter herein generally relates to a tower crane.

### BACKGROUND

Tower cranes have high lifting height, can lift loads, and have a large working pick-up area. However, serious accidents frequently occur in the operating process of the tower crane, which seriously threatens lives of workers and property safety of construction sites. For example, when a hook of the tower crane performs a lifting movement, the driver needs to observe whether there is an obstacle within a movement range of the hook to prevent the load from colliding with the obstacle. However, it is difficult for the driver to see clearly around the hook because of the distance between the driver and the hook.

Therefore, there is room for improvement within the art.

### BRIEF DESCRIPTION OF THE DRAWINGS

Implementations of the present technology will now be described, by way of example only, with reference to the attached figures.

FIG. 1 is a general view of an embodiment of a tower crane.

FIG. 2 is an architectural module diagram of the tower crane in FIG. 1.

FIG. 3 is a general view of a detector of the tower crane in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

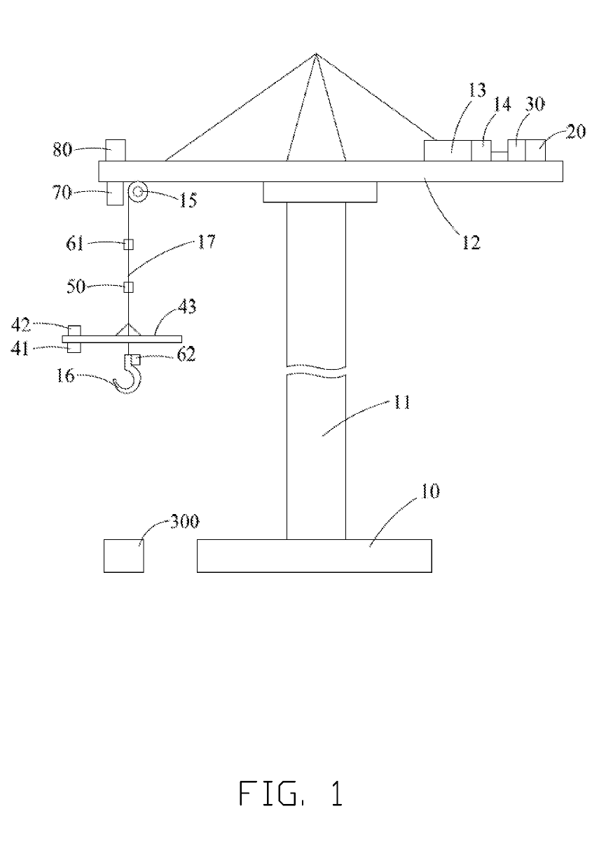

Referring to FIG. 1, an embodiment of a tower crane 100 may include a base 10, a tower body 11, a cargo boom 12, a spool 13, a motor 14, a pulley 15, and a hook 16. The tower body 11 is fixed to the base 10 and extends upwards from the base 10. The cargo boom 12 is mounted on an end of the tower body 11 and away from the base 10. The spool 13 is positioned on one end of the cargo boom 12, and the pulley 15 is mounted on the other end of the cargo boom 12. A tow rope/cable 17 of the spool 13 rolls around the pulley 15 and connects to the hook 16. The motor 14 is positioned on the cargo boom 12 and coupled to the spool 13. The motor 14 causes the spool 13 to rotate back and forth during an operation to drive the tow rope 17 on the spool 13 up or down, so that the hook 16 lifts the load 300.

The tower crane 100 may further include a swing mechanism (not shown in the figures). The swing mechanism is positioned between the tower body 11 and the cargo boom 12, and is configured to connect the cargo boom 12 to the tower body 11 and cause the cargo boom 12 to rotate relative to the axis of the tower crane 100, etc. The tower crane 100 may further include a trolley mechanism (not shown in the figures). The trolley mechanism is positioned between the cargo boom 12 and the hook 16, and is configured to connect the pulley 15 to the cargo boom 12 and cause the pulley 15 to move relative to the axis of boom 12. The swing mechanism and the trolley mechanism are well known existing devices, so no detail explanation is presented herein.

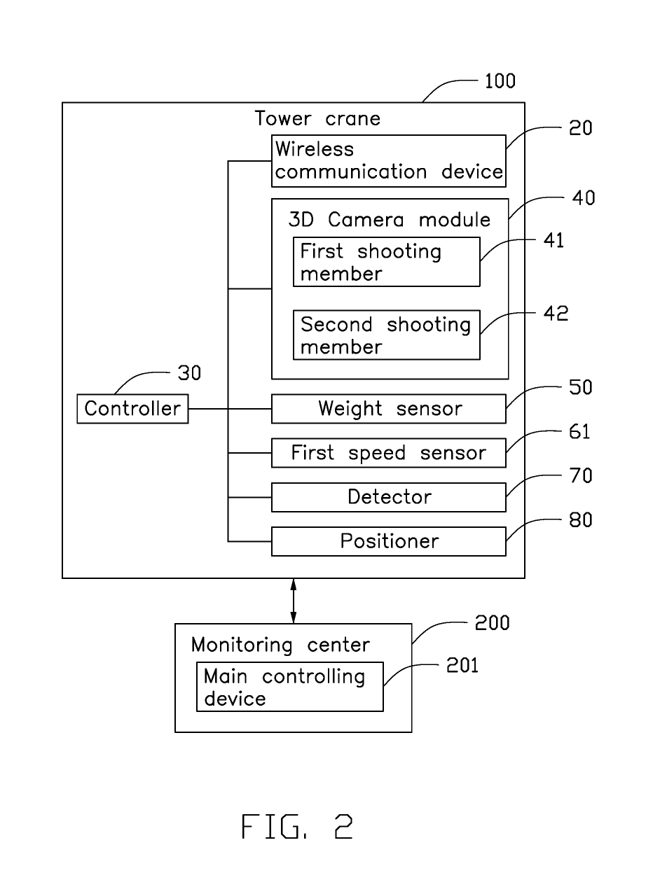

Referring to FIG. 1 and FIG. 2, the tower crane 100 further includes a wireless communication device 20 and a controller 30 coupled to the wireless communication device 20. The wireless communication device 20 and the controller 30 may be positioned on the tower body 11 or on the cargo boom 12. In this embodiment, the wireless communication device 20 and the controller 30 are both positioned on the cargo boom 12, adjacent to the motor 14. The wireless communication device 20 communicates between the tower crane 100 and a monitoring center 200, typically at ground level. In other words, the tower crane 100 communicates with the monitoring center 200 through the wireless communication device 20. The wireless communication device 20 supplies wireless communication by, for example, Wi-Fi, BLUETOOTH, or infrared technology.

The monitoring center 200 includes a main controlling device 201 with wireless remote control function. The main controlling device 201 may be a remote control device, a smart phone, or a tablet computer. An operator can control the tower crane 100 to perform operations using the main controlling device 201. For example, the tower crane 100 may be remotely controlled to lift or swing.

Specifically, the motor 14, the swing mechanism, and the trolley mechanism are electrically connected with the controller 30. Crane operator can press buttons of the main controlling device 201 according to actual needs, so that the main controlling device 201 generates a coded remote control signal corresponding to the button and transmits the coded remote control signal to the wireless communication device 20. The controller 30 obtains the coded remote control signal received by the wireless communication device 20, decodes the coded remote control signal, and controls the motor 14, the swing mechanism, or the trolley mechanism to carry out the operations according to the decoded signal. Thus, the operator can control the tower crane 100 through the monitoring center 200 to replace traditional cab control mode and construction site safety can be improved.

The tower crane 100 further includes a 3D camera module 40 having a connection with the controller 30. In an embodiment, the 3D camera module 40 is wireless and communicates with the controller 30 through the wireless communication device 20. The 3D camera module 40 may be on the tow rope 17, adjacent to the hook 16, or on the hook 16, itself In the embodiment, a supporting board 43 is fixed on an end of the tow rope 17 towards the hook 16, and the 3D camera module 40 is mounted on the supporting board 43.

The 3D camera module 40 includes a first camera 41 and a second camera 42. The first camera 41 and the second camera 42 are positioned on opposite sides of the supporting board 43. The first camera 41 faces the hook 16, and the second camera 42 faces away from the hook 16. The 3D camera module 40 may further include two connecting lines (not shown in figures), opposite ends of the supporting board 43 are connected to the tow rope 17 via the two connecting lines to form a stable triangular structure.

The first camera 41 is configured to take images, in real time, within a field of view of the first camera 41, and the second camera 42 is configured to take images, in real time, within a field of view of the second camera 42. The controller 30 is configured to obtain the images taken by the first camera 41 when the hook 16 lifts the load 300 downwards, and is configured to obtain the images taken by the second camera 42 when the hook 16 lifts the load 300 upwards. The controller 30 is further configured to detect whether there are obstacles within the images taken by the first camera 41 and/or the second camera 42. When there is an obstacle within the images, it indicates that the load 300 is too close to the obstacle, and the controller 30 accordingly controls the motor 14 to reduce working speed or stop working to avoid collision between the load 300 and the obstacle. In an embodiment, the first camera 41 and the second camera 42 are CCD stereoscopic cameras.

The controller 30 is further configured to generate a first alerting signal when there is an obstacle within the image, and transmit the first alerting signal to the main controlling device 201 through the wireless communication device 20. When the main controlling device 201 receives the first alerting signal, the main controlling device 201 alarms to notice ground workers removing the obstacle timely.

In an embodiment, the motor 14 is a multispeed motor. A working speed of the motor 14 is configured to be adjusted by the controller 30, so that lifting speeds of the tow rope 17 and the hook 16 are accordingly adjusted. The controller 30 is further configured to detect whether the load 300 appears in the image taken by the first camera 41 when the hook 16 moves in a first predetermined speed downward to the load 300. If the load 300 is not in the image, it illustrates that the hook 16 is far away from the load 300, and the controller 30 is configured to adjust the motor 14 to work in a speed faster than or equal to the first predetermined speed. If the load 300 appears in the image, it illustrates that the hook 16 is close to the load 300, and the controller 30 is configured to adjust the motor 14 to work in a speed lower than the first predetermined speed.

The tower crane 100 further includes a first speed sensor 61 and a second speed sensor 62. The first speed sensor 61 is positioned on the tow rope 17, and the second speed sensor 62 is positioned on the hook 16. The first speed sensor 61 and the second speed sensor 62 can both communicate with the controller 30. In an embodiment, the first speed sensor 61 and the second speed sensor 62 communicate with the controller 30 through the wireless communication device 20. The first speed sensor 61 is configured to sense a first speed of the tow rope 17 when the hook 16 lifts the load 300 and moves downwards. The second speed sensor 62 is configured to sense a second speed of the hook 16 when the hook 16 lifts the load 300 and moves downwards. The controller 30 is further configured to obtain the first speed and the second speed, and judge whether the first speed is faster than the second speed. When the first speed is faster than the second speed, it means that the hook 16 may be outside of the control of the tow rope 17, the controller 30 is configured to lower the working speed of the motor 14 to lower a rotary speed of the spool 13 until the first speed being equal to the second speed. When the first speed is faster than the second speed, the controller 30 is further configured to generate a second alerting signal and transmit the second alerting signal to the main controlling device 201 through the wireless communication device 20. When the main controlling device 201 receives the second alerting signal, the main controlling device 201 alarms to notice the ground workers that the hook 16 may be out of control of the tow rope 17. In other embodiments, the first speed sensor 61 may be omitted, the controller 30 may be configured to obtain the working speed of the motor 14 and accordingly calculate the first speed of the tow rope 17.

The tower crane 100 further includes a weight sensor 50 having a connection with the controller 30. In an embodiment, the weight sensor 50 wirelessly communicates with the controller 30 through the wireless communication device 20. The weight sensor 50 is positioned on the tow rope 17. The weight sensor 50 is configured to detect the weight of any load 300 which is lifted by the hook 16. The controller 30 is further configured to obtain the weight of the load 300, and determine whether the weight of the load 300 is heavier than a first predetermined weight. When the weight of the load 300 the is less than a first predetermined weight, the controller 30 is accordingly configured to adjust the motor 14 to work in a speed faster than or equal to a second predetermined speed. When the weight of the load 300 is heavier than or equal to the first predetermined weight, the controller 30 is accordingly configured to adjust the motor 14 to work in a speed lower than the second predetermined speed. The second predetermined speed may or may not be equal to the first predetermined speed.

When the weight of the load 300 is heavier than or equal to a second predetermined weight (safety weight), the controller 30 is configured to stop the motor 14 working to avoid breaking of the tow rope 17. The controller 30 is further configured to generate a third alerting signal when the weight of the load 300 is heavier than or equal to the second predetermined weight, and transmit the first alerting signal to the main controlling device 201 through the wireless communication device 20. When the main controlling device 201 receives the third alerting signal, the main controlling device 201 alarms to notice the ground workers that the current weight of the load 300 is too heavy.

The tow rope 17 is entwisted by a plurality of wires. In an embodiment, the tow rope 17 is a cable made of stainless steel. The tower crane 100 further includes a detector 70. The detector 70 is positioned on the trolley mechanism or the cargo boom 12. In an embodiment, the detector 70 is positioned on the cargo boom 12 and adjacent to the tow rope 17. The detector 70 is configured to detect whether the tow rope 17 is broken.

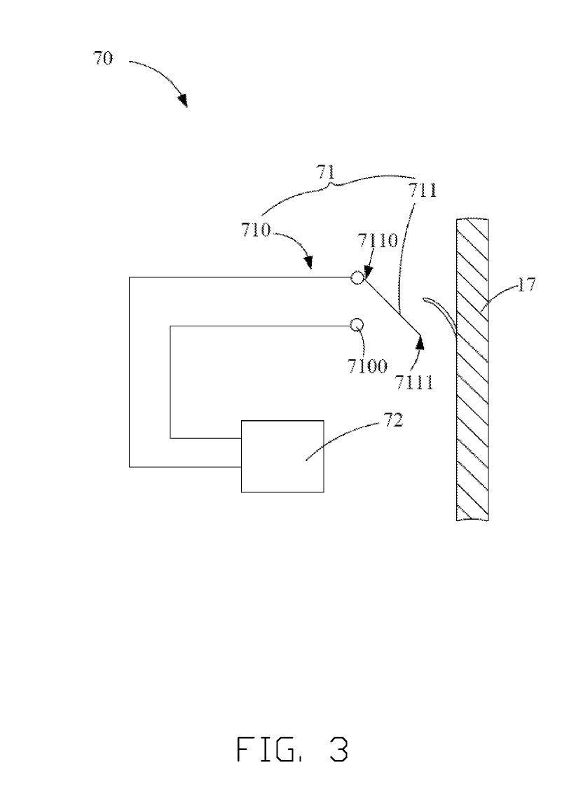

Referring to FIG. 1 and FIG. 3, the detector 70 includes a micro-switch 71 and an alarm 72. The micro-switch 71 is positioned on the trolley mechanism or the cargo boom 12. In an embodiment, the micro-switch 71 is positioned on the cargo boom 12 and adjacent to the tow rope 17.

The micro-switch 71 includes a switch 710 and a touching sheet 711. The switch 710 has two touching points 7100 formed thereon. A fixing end 7110 of the touching sheet 711 is fixed on one of the two touching points 7100. The alarm 72 is coupled to the micro-switch 71. An input end and an output end of the alarm 72 are respectively connected to the two touching points 7100 of the switch 710. The touching sheet 711 further includes a free end 7111 opposite away from the fixing end 7110. The free end 7111 is adjacent to the tow rope 17. When at least one of the wires of the tow rope 17 is broken, the broken wire gradually protrudes outwards to contact the touching sheet 711. When the broken wire contacts the touching sheet 711, the free end 7111 of the touching sheet 711 is turned by the broken wire to make contact with another touching point 7100, so that the two touching points 7100 of the micro-switch 71 are bridged and the alarm 72 alarms. In an embodiment, the alarm 72 is a buzzer alarm or an indicator light. In other embodiments, the alarm 72 may be omitted. The detector 70 may have a communication connection with the controller 30. The controller 30 may be configured to generate a fourth alerting signal when the two touching points 7100 of the micro-switch 71 are conducted, and transmit the fourth alerting signal to the main controlling device 201 through the wireless communication device 20. When the main controlling device 201 receives the fourth alerting signal, the main controlling device 201 alarms to notice the ground workers.

In an embodiment, the tower crane 100 further includes a positioner 80. The positioner 80 is positioned on the cargo boom 12 and adjacent to the pulley 15. The positioner 80 is wirelessly coupled to the wireless communication device 20. The positioner 80 is configured to sense position coordinates of the cargo boom 12 and transmit the position coordinates of the cargo boom 12 to the monitoring center 200 through the wireless communication device 20. The monitoring center 200 is configured to collect all the position coordinates of the cargo boom 12 from different tower cranes 100. The monitoring center 200 is further configured to record all position coordinates of the obstacles, and draw an electronic map according to the position coordinates of the cargo boom 12 and the position coordinates of the obstacles.

The positioner 80 has a connection with the controller 30. In an embodiment, the positioner 80 communicates with the controller 30 through the wireless communication device 20. The controller 30 is configured to obtain the position coordinate of the cargo boom 12 sensed by the positioner 80 in a real time and the electronic map drawn by the monitoring center 200. Safety of the tower crane 100 is thus constantly monitored. For example, when a distance between the cargo boom 12 and the obstacle is greater than a predetermined distance, it means that the tower crane 100 is safe. The controller 30 is further configured to plan a safe route for listing according to the position coordinates of the cargo boom 12 sensed by the positioner 80 and the electronic map drawn by the monitoring center 200. The safe route can make the tower crane 100 remain safe until the cargo boom 12 reaches a target position. The controller 30 is further configured to control lifting, swinging, and turning of the tower crane 100 according to the safe route, so that the cargo boom 12 safely reaches the target position. In an embodiment, the positioner 80 is a GPS positioner.

The embodiments shown and described above are only examples. Many details are often found in the art such as the other features of a tower crane. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A tower crane comprising:
a cargo boom;
a spool positioned on one end of the cargo boom;
a motor positioned on the cargo boom and coupled to the spool;
a pulley mounted on the other end of the cargo boom;
a hook, a tow rope of the spool rolling around the pulley and connecting to the hook;
a 3D camera module locate on the tow rope and adjacent to the hook, comprising:
a first camera facing the hook, the first camera being configured to taken images, in real time, within a field of view of the first camera; and
a second camera facing away from the hook, the second camera being configured to taken images, in real time, within a field of view of the second camera;
a controller coupled to the 3D camera module and the motor; and
wherein the controller is configured to:
obtain the images taken by the first camera when the hook lifts a load downwards, and obtain the images taken by the second camera when the hook lifts the load upwards;
detect whether there are obstacles within the images taken by the first camera and the second camera; and
control the motor to reduce working speed or stop when there is an obstacle within the images taken by the first camera or the second camera.

2. The tower crane of claim 1, wherein a working speed of the motor is configured to be adjusted by the controller, the controller is further configured to detect whether the load is in the images taken by the first camera when the hook moves in a first predetermined speed downward to the load; when the load is not in the images taken by the first camera, the controller adjusts the motor to work in a speed faster than or equal to the first predetermined speed; when the load is in the images taken by the first camera, the controller adjusts the motor to work in a speed lower than the first predetermined speed.

3. The tower crane of claim 1, further comprising a wireless communication device positioned on the cargo boom and adjacent to the motor; wherein the controller is coupled to the wireless communication device, the wireless communication device is configured to supply wireless communication between the tower crane and a main controlling device of a monitoring center; the controller is further configured to generate a first alerting signal when there is an obstacle within the images taken by the first camera or the second camera, and transmit the first alerting signal to the main controlling device through the wireless communication device, the main controlling device alarms after receiving the first alerting signal.

4. The tower crane of claim 3, wherein the controller is further configured to obtain a first speed the tow rope and a second speed of the hook when the hook lifts the load and moves downwards, and judge whether the first speed is faster than the second speed; when the first speed is faster than the second speed, the controller is configured to lower the working speed of the motor to lower a rotary speed of the spool until the first speed being equal to the second speed.

5. The tower crane of claim 4, wherein when the first speed is faster than the second speed, the controller is further configured to generate a second alerting signal and transmit the second alerting signal to the main controlling device through the wireless communication device; the main controlling device alarms after receiving the second alerting signal.

6. The tower crane of claim 4, further comprising a first speed sensor positioned on the tow rope and a second speed sensor positioned on the hook, wherein the first speed sensor and the second speed sensor both have a communication connection with the controller through the wireless communication device; the first speed sensor is configured to sense the first speed of the tow rope, and the second speed sensor is configured to sense the second speed of the hook.

7. The tower crane of claim 3, further comprising a weight sensor positioned on the tow rope, wherein the weight sensor wirelessly communicates with the controller through the wireless communication device; the weight sensor is configured to detect a weight of the load when the hook lifts the load, the controller is further configured to obtain the weight of the load and judge whether the weight of the load is heavier than a first predetermined weight; when the weight of the load the is less than a first predetermined weight, the controller is accordingly configured to adjust the motor to work in a speed faster than or equal to a second predetermined speed; when the weight of the load is heavier than or equal to the first predetermined weight, the controller is accordingly configured to adjust the motor to work in a speed lower than the second predetermined speed.

8. The tower crane of claim 7, wherein the controller is further configured to determine whether the weight of the load is heavier than a second predetermined weight; if the weight of the load 300 is heavier than or equal to the second predetermined weight, the controller is configured to stop the motor working.

9. The tower crane of claim 8, wherein the controller is further configured to generate a third alerting signal when the weight of the load is heavier than or equal to the second predetermined weight, and transmit the first alerting signal to the main controlling device through the wireless communication device, and the main controlling device alarms after receiving the third alerting signal.

10. The tower crane of claim 3, further comprising a detector positioned on the cargo boom and adjacent to the tow rope, wherein the detector is configured to detect whether the tow rope is broken.

11. The tower crane of claim 10, wherein the tow rope is a cable entwisted by a plurality of wires, the detector comprises a micro-switch and an alarm, the micro-switch is positioned on cargo boom and adjacent to the tow rope, the micro-switch comprises a switch having two touching points formed thereon and a touching sheet, a fixing end of the touching sheet is fixed on one of the two touching points, an input end and an output end of the alarm are respectively connected to the two touching points of the switch, the touching sheet further comprises a free end opposite away from the fixing end, and the free end is adjacent to the tow rope; when at least one of the wires of the tow rope is broken, broken wires gradually protrude outwards to contact and turn the touching sheet until the two touching points bridged.

12. The tower crane of claim 11, wherein the detector wirelessly communicates with the controller through the wireless communication device, the controller is further configured to generate a fourth alerting signal when the two touching points of the micro-switch are conducted, and transmit the fourth alerting signal to the main controlling device through the wireless communication device, and the main controlling device alarms after receiving the fourth alerting signal.

13. The tower crane of claim 3, further comprising a positioner positioned on the cargo boom and adjacent to the pulley, wherein the positioner is wirelessly coupled to the wireless communication device, the positioner is configured to sense position coordinates of the cargo boom and transmit the position coordinates of the cargo boom to the monitoring center through the wireless communication device; and the monitoring center is configured to collect all the position coordinates of the cargo boom from different kinds of the tower cranes, the monitoring center is further configured to record all position coordinates of the obstacles, and draw an electronic map according to the position coordinates of the cargo boom and the position coordinates of the obstacles, the positioner has a communication connection with the controller, and the controller is further configured to obtain the position coordinate of the cargo boom sensed by the positioner and the electronic map drawn by the monitoring center, and then accordingly judge whether the tower crane is safe.

14. The tower crane of claim 13, wherein the controller is further configured to plan a safe route according to the position coordinates of the cargo boom sensed by the positioner and the electronic map drawn by the monitoring center, the safe route ensures the tower crane remain safe until the cargo boom reaching a target position.

15. The tower crane of claim 14, wherein the controller is further configured to control lifting, swinging, and turning of the tower crane according to the safe route, so that the cargo boom safely reaches the target position.

16. The tower crane of claim 1, wherein a supporting board is supplied to be fixed on an end of the tow rope towards the hook, and the first camera and the second camera are positioned on two opposite sides of the supporting board, the first camera faces the hook, and the second camera is opposite away from the hook.

17. The tower crane of claim 1, further comprising a base and a tower body, wherein the tower body is fixed to the base and extends upwards from the base, the cargo boom is mounted on an end of the tower body and away from the base.
